(19) United States
(12) Patent Application Publication
(10) Pub. No.: US 2004/0124702 A1
(43) Pub. Date: Jul. 1, 2004

(54) Multiple functional gear shifting lever head

(76) Inventor: Yao-Huang Liu, Taichung (TW)

Correspondence Address: Yao-Huang Liu, 58, MA YUAN WEST ST., TAICHUNG, TW

(21) Appl. No.: 10/330,976

(22) Filed: Dec. 25, 2002

(51) Int. Cl. H02G 3/00

(52) U.S. Cl. 307/9.1

(57) ABSTRACT

A multiple functional gear shifting lever head has a main seat, a cover engaging with the main seat, an integrated circuit board disposed in the cover, and a power source board disposed in the cover. The cover has a center button to contact the integrated circuit board, and a plurality of bulb holders. A plurality of bulbs are disposed on the integrated circuit board. Each bulb holder receives one of the bulbs. A plurality of cells are disposed on the power source board. A pair of power source connected wires are connected to a power source connector and the integrated circuit board. A pair of electric wires are connected to the integrated circuit board and the power source board. A locking collar is disposed on a bottom of the main seat.

### BACKGROUND OF THE INVENTION

The present invention relates to a gear shifting lever head. More particularly, the present invention relates to a multiple functional gear shifting lever head which illuminates light.

Referring to FIG. 1, a conventional gear shifting lever head has a main seat 7, a cover 73 engaging with the main seat 7, a disk 71 disposed in the main seat 7, and a plurality of lamps 72 disposed on the disk 71. The cover 73 is made of a semi-transparent acrylic material. However, the lamps 72 illuminate dim light only.

### SUMMARY OF THE INVENTION

An object of the present invention is to provide a multiple functional gear shifting lever head which illuminates flashing light.

Accordingly, a multiple functional gear shifting lever head comprises a main seat, a cover engaging with the main seat, a power source board disposed in the main seat, and an integrated circuit board disposed in the main seat. A bulb is disposed on the integrated circuit board. The main seat has a disk and a switch. An electric wire is connected to the switch and the power source board. The disk has a plurality of threaded holes. A plurality of bolts fasten the integrated circuit board, the power source board, and the disk.

Accordingly, another multiple functional gear shift-ing lever head comprises a main seat, a cover engaging with the main seat, an integrated circuit board disposed in the cover, and a power source board disposed in the cover. The cover has a center button to contact the integrated circuit board, and a plurality of bulb holders. A plurality of bulbs are disposed on the integrated circuit board. Each of the bulb holders receives one of the bulbs. A plurality of cells are-disposed on the power source board. A pair of power source connected wires are connected to a power source connector and the integrated circuit board. A pair of electric wires are connected to the integrated circuit board and the power source board.

In accordance with a first preferred embodiment of the present invention, a multiple functional gear shifting lever head comprises a main seat, a cover engaging with the main seat, an integrated circuit board disposed in the cover, and a power source board disposed in the cover. The cover has a center button to contact the integrated circuit board, and a plurality of bulb holders. A plurality of bulbs are disposed on the integrated circuit board. Each of the bulb holders receives one of the bulbs. A plurality of cells are disposed on the power source board. A pair of power source connected wires are connected to a power source connector and the integrated circuit board. A pair of electric wires are connected to the integrated circuit board and the power source board. A locking collar is disposed on a bottom of the main seat.

In accordance with a second preferred embodiment of the present invention, a multiple functional gear shifting lever head comprises a main seat, a cover engaging with the main seat, an integrated circuit board disposed in the cover, and a power source board disposed in the cover. The cover has a center button to contact the integrated circuit board, and a plurality of bulb holders. A plurality of bulbs are disposed on the integrated circuit board. Each of the bulb holders receives one of the bulbs. A plurality of cells are disposed on the power source board. A pair of power source connected wires are connected to a power source connector and the integrated circuit board. A pair of electric wires are connected to the integrated circuit board and the power source board. A battery container is disposed on a bottom of the main seat. An end lid is disposed on a bottom of the battery container. The battery container has an additional power source connector engaging with the power source connector. The battery container receives a plurality of batteries.

In accordance with a third preferred embodiment of the present invention, a multiple functional gear shifting lever head comprises a main seat, a cover engaging with the main seat, a power source board disposed in the main seat, and an integrated circuit board disposed in the main seat. A bulb is disposed on the integrated circuit board. The main seat has a disk, a switch, and an inner thread. An electric wire is connected to the switch and the power source board. The disk has a plurality of threaded holes. A plurality of bolts fasten the integrated circuit board, the power source board, and the disk. The integrated circuit board has a plurality of periphery notches to receive the bolts. The power source board has a plurality of periphery recesses to receive the bolts. The cover has a face pattern and an outer thread to engage with the inner thread of the main seat.

### BRIEF DESCRIPTION OF THE DRAWINGS

FIG. 1 is a perspective view of a conventional gear shifting lever head of the prior art;

FIG. 2 is a perspective exploded view of a multiple functional gear shifting lever head of a first preferred embodiment in accordance with the present invention;

FIG. 3 is a perspective assembly view of a multiple functional gear shifting lever head of a first preferred embodiment in accordance with the present invention;

FIG. 4 is a sectional assembly view of a multiple functional gear shifting lever head of a first preferred embodiment in accordance with the present invention;

FIG. 5 is a perspective exploded view of a multiple functional gear shifting lever head of a second preferred embodiment in accordance with the present invention;

FIG. 6 is a perspective assembly view of a multiple functional gear shifting lever head of a second preferred embodiment in accordance with the present invention;

FIG. 7 is a sectional assembly view of a multiple functional gear shifting lever head of a second preferred embodiment in accordance with the present invention;

FIG. 8 is a perspective exploded view of a multiple functional gear shifting lever head of a third preferred embodiment in accordance with the present invention; and

FIG. 9 is a sectional assembly view of a multiple functional gear shifting lever head of a third preferred embodiment in accordance with the present invention.

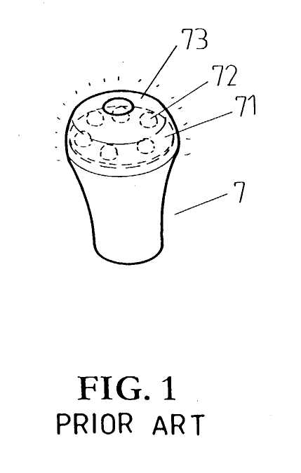

### DETAILED DESCRIPTION OF THE INVENTION

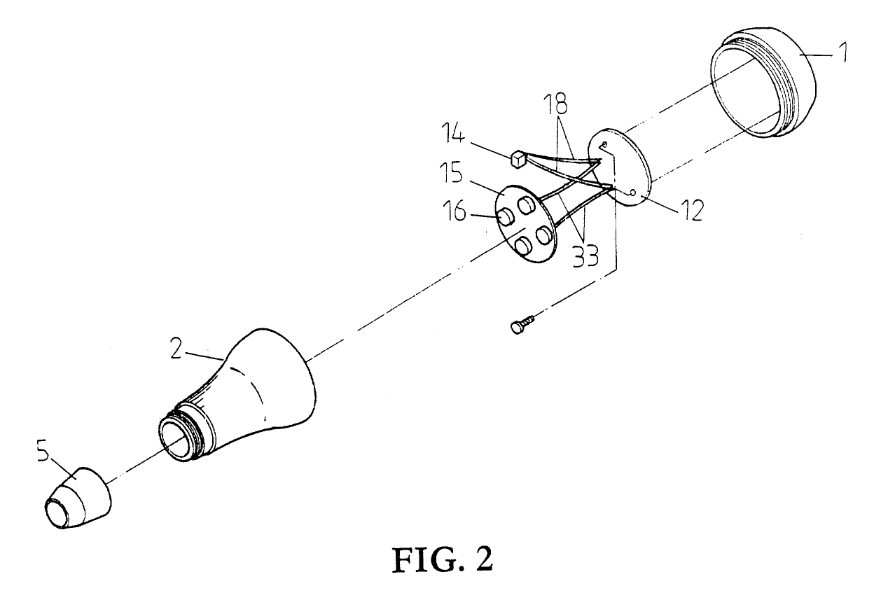

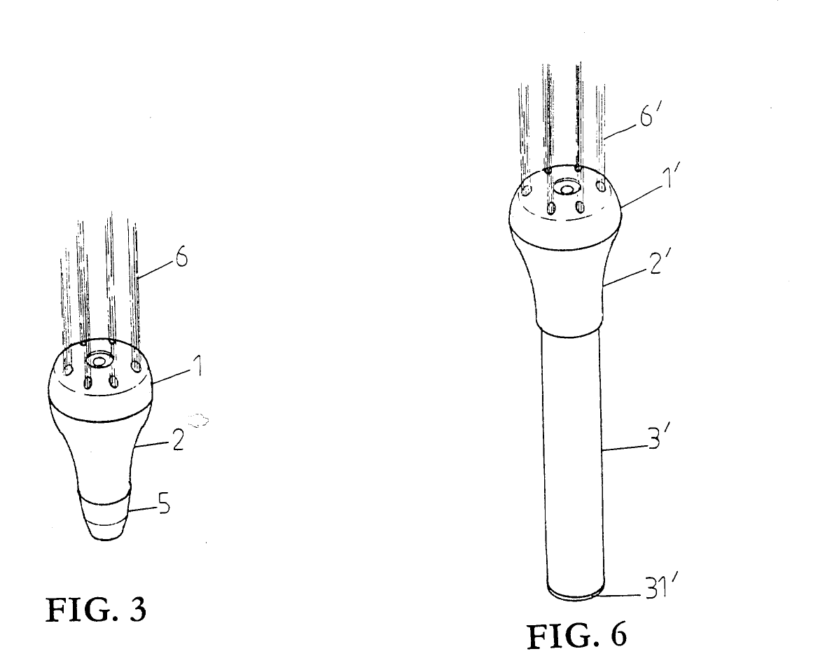

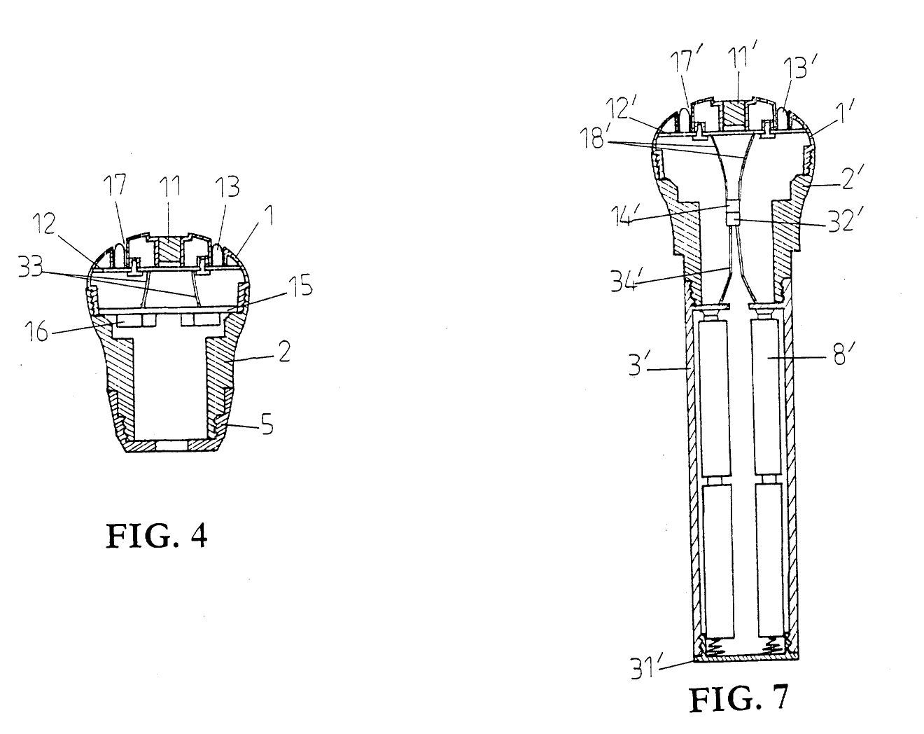

Referring to FIGS. 2 to 4, a first multiple functional gear shifting lever head comprises a main seat 2, a cover 1 engaging with the main seat 2, an integrated circuit board 12 disposed in the cover 1, and a power source board 15 disposed in the cover 1.

The cover 1 has a center button 11 to contact the integrated circuit board 12, and a plurality of bulb holders 17.

A plurality of bulbs 13 are disposed on the integrated circuit board 12.

Each of the bulb holders 17 receives one of the bulbs 13.

A plurality of cells 16 are disposed on the power source board 15.

A pair of power source connected wires 18 are connected to a power source connector 14 and the integrated circuit board 12.

A pair of electric wires 33 are connected to the integrated circuit board 12 and the power source board 15.

A locking collar 5 is disposed on a bottom of the main seat 2.

Each bulb 13 will illuminate flashing light 6.

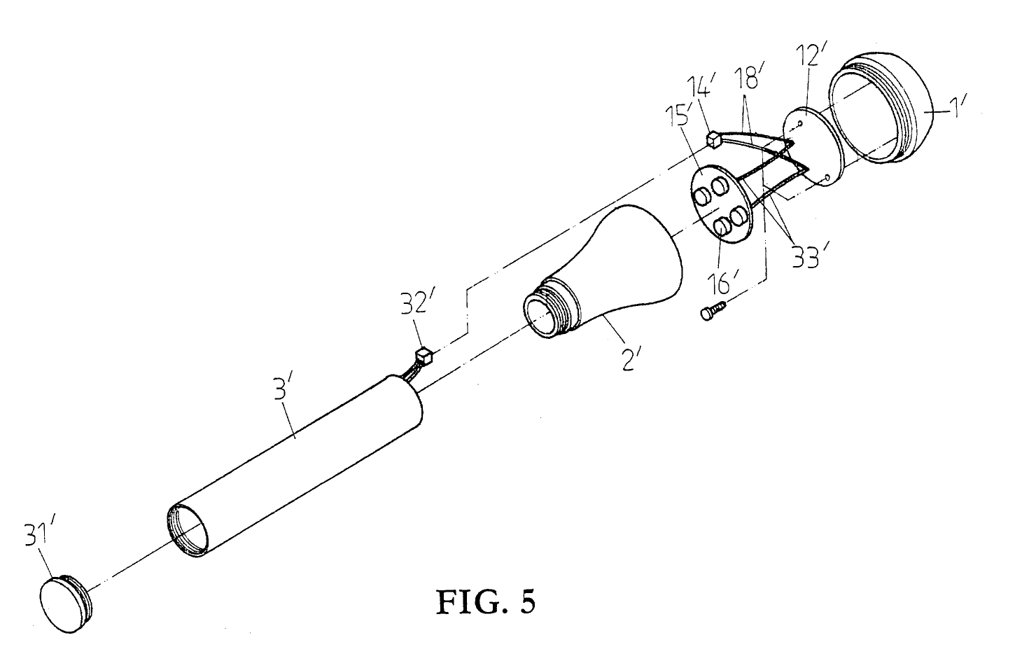

Referring to FIGS. 5 to 7, a second multiple functional gear shifting lever head comprises a main seat 2′, a cover 1′ engaging with the main seat 2′, an integrated circuit board 12′ disposed in the cover 1′, and a power source board 15′ disposed in the cover 1′.

The cover 1′ has a center button 11′ to contact the integrated circuit board 12′, and a plurality of bulb holders 17′.

A plurality of bulbs 13′ are disposed on the integrated circuit board 12′.

Each of the bulb holders 17′ receives one of the bulbs 13′.

A plurality of cells 16′ are disposed on the power source board 15′.

A pair of power source connected wires 18′ are connected to a power source connector 14′ and the integrated circuit board 12′.

A pair of electric wires 33′ are connected to the integrated circuit board 12′ and the power source board 15′.

A battery container 3′ is disposed on a bottom of the main seat 2′.

An end lid 31′ is disposed on a bottom of the battery container 3′.

The battery container 3′ has an additional power source connector 32′ engaging with the power source connector 14′.

The battery container 3′ receives a plurality of batteries 8′.

Each bulb 13′ will illuminate flashing light 6′.

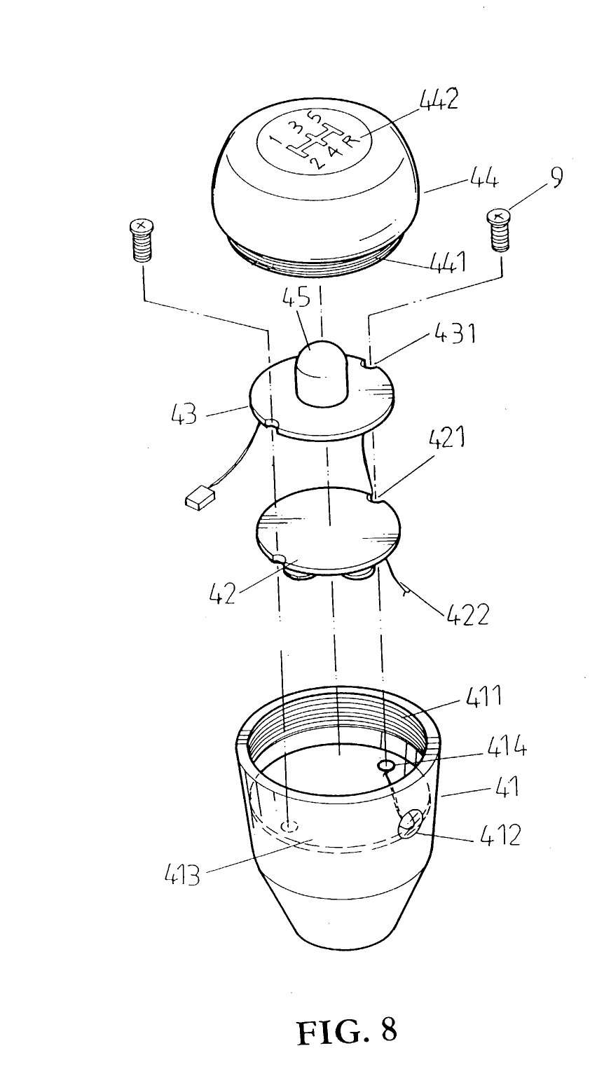

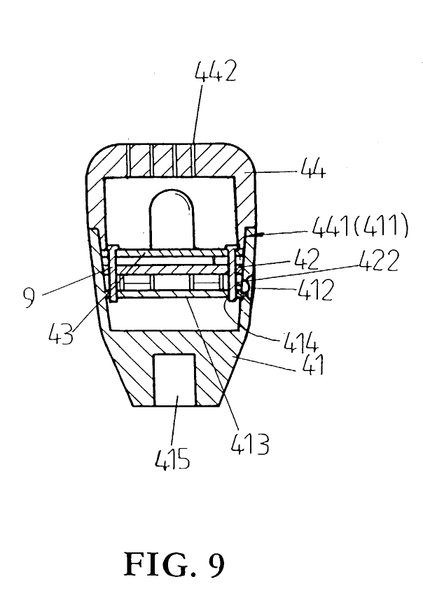

Referring to FIGS. 8 and 9, a third multiple functional gear shifting lever head comprises a main seat 41, a cover 44 engaging with the main seat 41, a power source board 42 disposed in the main seat 41, and an integrated circuit board 43 disposed in the main seat 41.

A bulb 45 is disposed on the integrated circuit board 43.

The main seat 41 has a disk 413, a switch 412, and an inner thread 411.

An electric wire 422 is connected to the switch 412 and the power source board 42.

The disk 413 has a plurality of threaded holes 414.

A plurality of bolts 9 fasten the integrated circuit board 43, the power source board 42, and the disk 413.

The integrated circuit board 43 has a plurality of periphery notches 431 to receive the bolts 9.

The power source board 42 has a plurality of periphery recesses 421 to receive the bolts 9.

The cover 44 has a face pattern 442 and an outer thread 441 to engage with the inner thread 411 of the main seat 41.

The invention is not limited to the above embodiment but various modification thereof may be made. Further, various changes in form and detail may be made without departing from the scope of the invention.

I claim:

1. A multiple functional gear shifting lever head comprises:
a main seat,
a cover engaging with the main seat,
a power source board disposed in the main seat,
an integrated circuit board disposed in the main seat,
a bulb disposed on the integrated circuit board,
the main seat having a disk and a switch,
an electric wire connected to the switch and the power source board,
the disk having a plurality of threaded holes, and
a plurality of bolts fastening the integrated circuit board, the power source board, and the disk.

2. A multiple functional gear shifting lever head comprises:
a main seat,
a cover engaging with the main seat,
an integrated circuit board disposed in the cover,
a power source board disposed in the cover,
the cover having a center button to contact the integrated circuit board, and a plurality of bulb holders,
a plurality of bulbs disposed on the integrated circuit board,
each of the bulb holders receiving one of the bulbs,
a plurality of cells disposed on the power source board,
a pair of power source connected wires connected to a power source connector and the integrated circuit board, and
a pair of electric wires connected to the integrated circuit board and the power source board.

3. A multiple functional gear shifting lever head as claimed in claim 1, wherein a locking collar is disposed on a bottom of the main seat.

4. A multiple functional gear shifting lever head as claimed in claim 1, wherein a battery container is disposed on a bottom of the main seat, an end lid is disposed on a bottom of the battery container, and the battery container has an additional power source connector engaging with the power source connector.
